(19) United States
(12) Patent Application Publication
(10) Pub. No.: US 2021/0045555 A1
(43) Pub. Date: Feb. 18, 2021

(54) Sharpoon (Spoon with knife)

(71) Applicant: Stephanie Ann Green, Milwaukie, OR (US)

(72) Inventor: Stephanie Ann Green, Milwaukie, OR (US)

(21) Appl. No.: 16/504,255

(22) Filed: Aug. 16, 2019

(51) Int. Cl. A47G 21/04; B26B 11/00; A47J 17/02

(52) U.S. Cl. CPC A47G 21/04; A47J 17/02; B26B 11/00

(57) ABSTRACT

The purpose of this patent application is to obtain a patent on the Sharpoon (Spoon with knife). The main purpose for this invention is to benefit anyone who cuts round fruit such as cantaloupe or watermelon. It will also benefit anyone who scoops ice cream as the Sharpoon can be used to cut right through frozen solid ice cream with ease. No more using a warming spoon or any other fancy equipment. The product mimics a spoon that can come in any size and shape and made from any material that has one side that has been grinded down to mimic a blade or knife. A huge audience will also be kid chefs to help them prevent cutting themselves. Moms will love this invention as it provides a safer environment for their young chefs. Older generations will benefit as this spoon will help cut with ease, which requires less strength.

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention is a new invention in which no patents or ideas already exist. This is a brand new product that will be brought to the market. It is a new product and that is standalone. The main impetus for the Sharpoon is to cut round fruit such as cantaloupe or watermelon with ease. It is also used for cutting ice cream instead of scooping ice cream. The product mimics a normal commercially available spoon, which has been augmented with a sharp razor/knife blade on one side.

Stephanie Ann Green is a full time working mother of 3 small kids with an MBA. Her house is comprised of a family of 5 and she is always cooking and chopping vegetables. One day in 2018, she was trying to cut the skin of the cantaloupe away from the fruit and the knife slipped and she cut her finger to the bone. She then thought about creating a spoon that has a bladed edge to quickly and safely cut round fruit.

### BRIEF SUMMARY OF THE INVENTION

As mentioned above, there is a huge market and need for this product. The main reason for this invention is for safety and to prevent cutting fingers while trying to cut the fruit away from the skin on fruits such as cantaloupe, apples, oranges, and mangos to name a few. It also works better than any ice cream scoop to cut through ice cream instead of scooping it.

### BRIEF DESCRIPTION OF THE SEVERAL VIEWS OF THE DRAWING

Please refer to the drawing which is located on a separate page. Each element is properly labeled.

### DETAILED DESCRIPTION OF THE INVENTION

There is no other invention like this one the market. All materials are on the market currently so it's a matter of assembling existing materials that are commercially available. A commercially off the shelf spoon is used and one of the horizontal sides is grinded down to render a blade.

### DRAWINGS

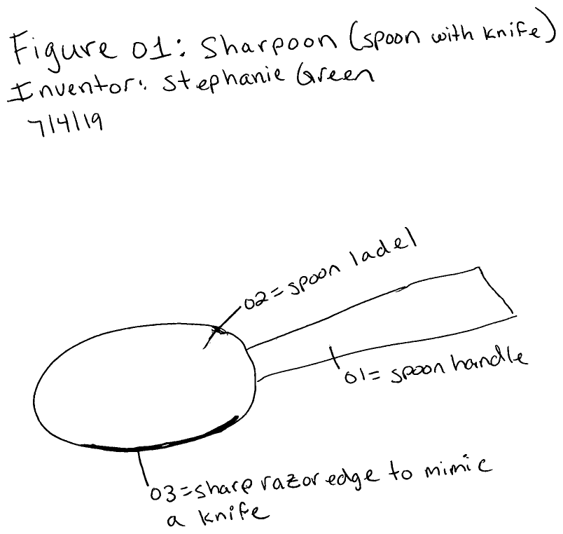

A sketch is attached as a separate drawing as FIG. 01.

Each item that is included in the drawing is labeled as follows:
01=The handle of the spoon.
02=The spoon ladle or main part of the spoon.
03=The sharp edge of the spoon that is used for cutting.

1. A spoon that has one sharp side that mimics a knife or blade that is used to help cut round fruit (separate skin from fruit) or used to cut ice cream instead of scooping it. All uses for the Sharpoon are in scope.
(a) a spoon, in all different sizes, made from any type of material that has a sharp side.
(b) the spoon is multipurpose and can be used to scoop and cut.
(c) a spoon that has one side that looks like a knife with a blade.
